(19) United States
(12) Patent Application Publication
(10) Pub. No.: US 2016/0102936 A1
(43) Pub. Date: Apr. 14, 2016

(54) VISUAL TRACER AND SOUND TRAINING DEVICE

(71) Applicant: SeaLamb Tactical, LLC, Minneapolis, MN (US)

(72) Inventors: Nathan Albert Seabrook, Minneapolis, MN (US); Keith Lamb, Guatemala City (GT)

(21) Appl. No.: 14/877,931

(22) Filed: Oct. 8, 2015

Related U.S. Application Data
(60) Provisional application No. 62/061,971, filed on Oct. 9, 2014.

(51) Int. Cl. F41A 33/04; G09B 9/00

(52) U.S. Cl. CPC F41A 33/04; G09B 9/003

(57) ABSTRACT

A visual tracer and sound training device for training in high threat environments. More specifically, a device comprising a barrel unit, a light unit attached to the barrel unit, an antenna, a removable remote control unit, a gearbox, a motor, a high-capacity hopper device, and speakers.

### CROSS-REFERENCE TO RELATED APPLICATION

This application claims the benefit of U.S. Provisional Application No. 62/061,971, filed Oct. 9, 2014, titled VISUAL TRACER AND SOUND TRAINING DEVICE.

### FIELD OF THE DISCLOSURE

The disclosed invention relates to a stationary training device for military, security contractors, and specialized law enforcement units working and operating in high threat permissive environments.

### BACKGROUND OF THE INVENTION

Military units, specialized law enforcement, and civilian high-threat security contractors are trained to react to direct action contacts and ambushes. It is common in these hostile and violent actions for light and heavy machine guns and assault rifles to be used. The weapons platforms used in such attacks often employ bullets called tracer rounds. These tracer rounds are small, pyrotechnic charges located in the base of the bullet. When the bullets are shot, they are ignited by the burning powder, which, in turn, creates a pyrotechnic composition that burns very brightly and makes the projectile visible to the naked eye. This enables the shooter to follow the projectile trajectory and make aiming corrections. It also allows an individual to mark a target for others to shoot at.

When used, tracers are usually loaded every fifth round in machine gun belts or magazines. This loading technique is referred to as a four-to-one tracer. Military, special police units, and private security contractors will sometimes load their magazines entirely with tracers to mark targets for their team members to fire at. Tracers are also sometimes placed two or three rounds from the bottom of magazines to alert the shooter that the weapon is almost empty.

A concept in military, security, and law enforcement is to “train as we fight.” Therefore, these specialized units need non-lethal training devices that will help to simulate the sights and sounds of tracer rounds being fired at them.

### SUMMARY OF THE INVENTION

The disclosed device is a visual tracer and sound training device. This non-lethal, specialized training device can provide members of the military, law enforcement, and specialized security organizations the ability to be exposed to simulated tracer rounds in a safe, controlled manner. Therefore, the individuals can train as they would fight and react properly in an actual situation in which real tracer rounds are being used.

### BRIEF DESCRIPTION OF THE DRAWINGS

FIG. 1 illustrates the disclosed visual tracer and sound training device according to one embodiment of the disclosed invention.

FIG. 2 illustrates the housing and carrying unit of the device according to one embodiment of the disclosed invention.

FIG. 3 illustrates a gearbox that can be used to shoot BBs from the device according to one embodiment of the disclosed invention.

FIG. 4 illustrates a barrel with an infrared device attached to the gearbox according to one embodiment of the disclosed invention.

FIG. 5 illustrates a motor that attaches to the trigger on the gearbox according to one embodiment of the disclosed invention.

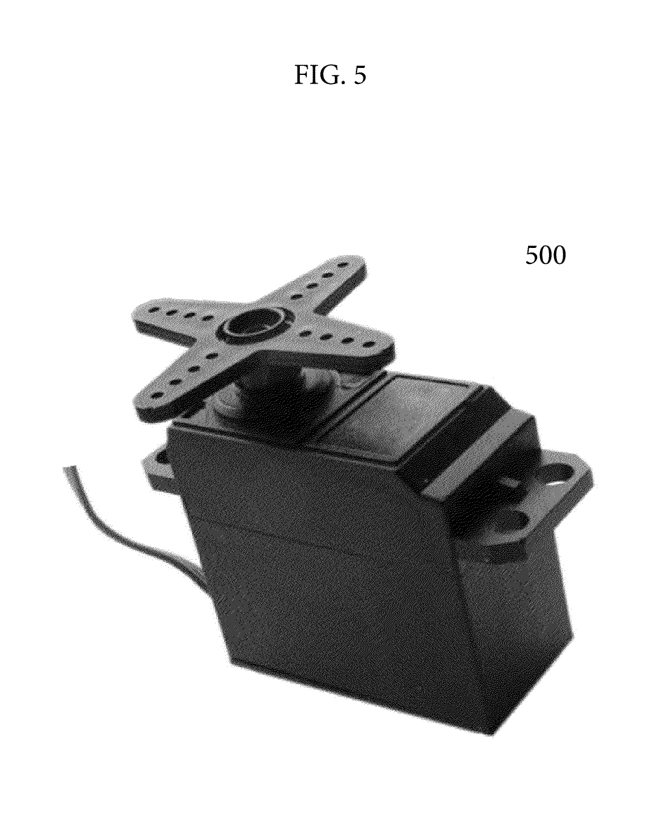

FIG. 6 illustrates a remote control unit used to control the device according to one embodiment of the disclosed invention.

FIG. 7 illustrates an antenna used on the device according to one embodiment of the disclosed invention.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims. It is understood that various omissions and substitutions of equivalents are contemplated as circumstances may suggest or render expedient, but these are intended to cover applications or embodiments without departing from the spirit or scope of the claims attached hereto. Also, it is to be understood that the phraseology and terminology used herein are for the purpose of description and should not be regarded as limiting.

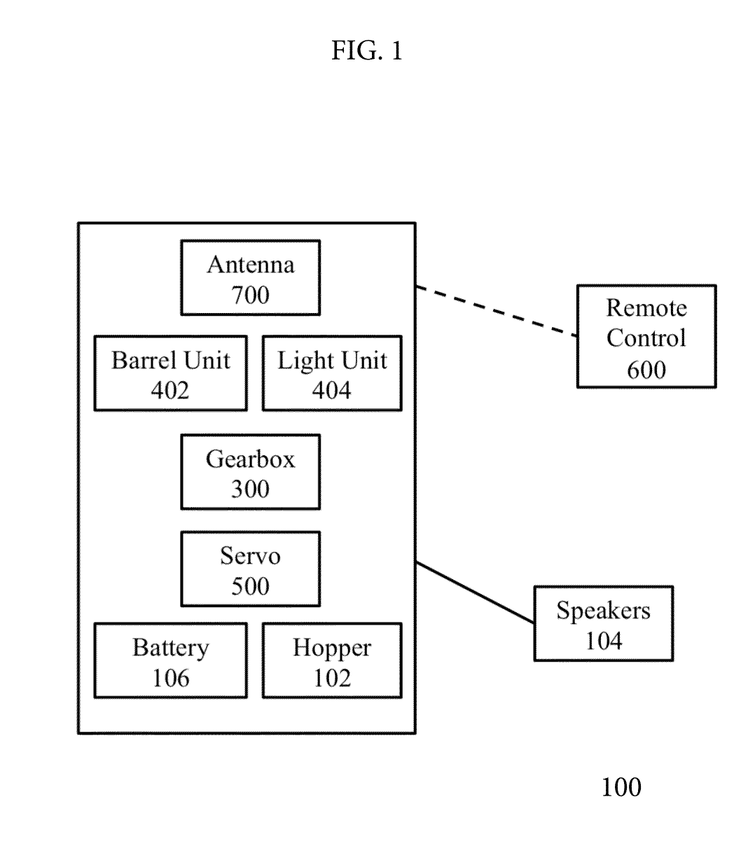

The disclosed device is a visual tracer and sound training device 100. It is a non-lethal, specialized training device that can provide members of the military, law enforcement, and specialized security organizations with the opportunity to train for hostile situations in a realistic setting where tracer rounds are used. More specifically, as illustrated in FIG. 1, the training device 100 can include an antenna 700 that receives a signal from a remote control unit 600, a barrel unit 402 that BBs shoot out of, a light unit 404 that activates BBs, a gearbox 300 that fires BBs, a servo 500 that motorizes the gearbox 300, a battery 106, a hopper 102 for holding BBs, and speakers 104 to make the training more realistic.

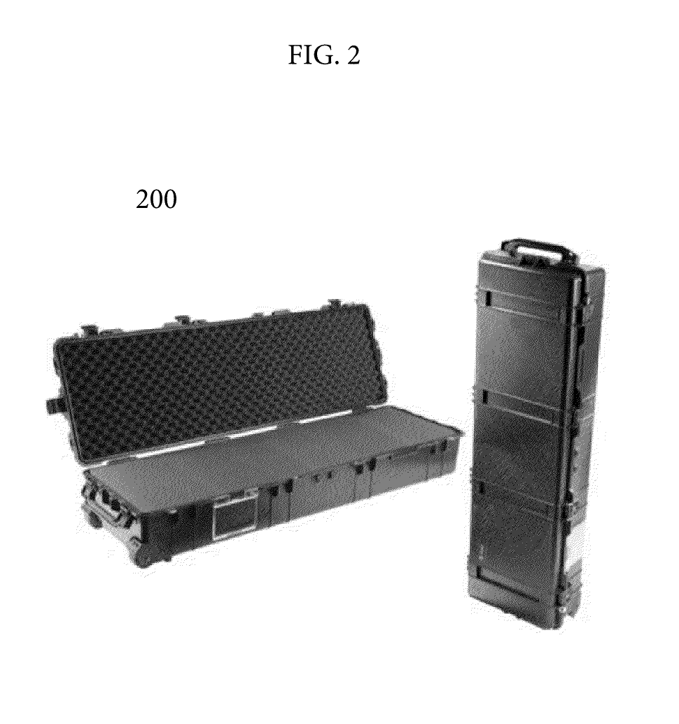

In one embodiment, the shell of the training device is a rectangular box 200, as illustrated in FIG. 2, and can be made of wood, plastic, metal, or composite. The dimensions of the box 200 can vary but, in one embodiment, are about six feet long by about two feet wide. The box 200 can have a small hole in the front from where a barrel unit 402 can protrude. The top of the box 200 can open and close using a series of hinges, thus allowing the training device to be prepared for use. In some embodiments, there are four hinges that are subdued and made of, for example, metal or plastic.

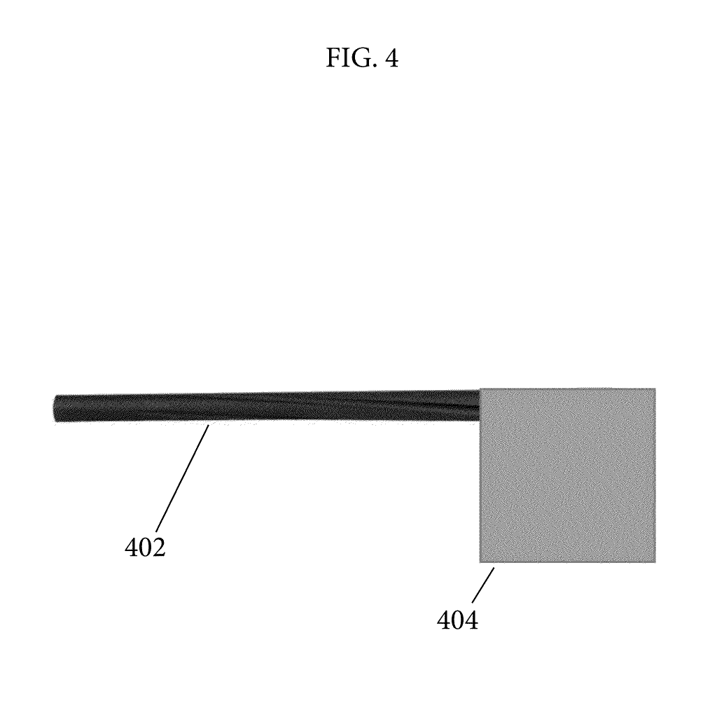

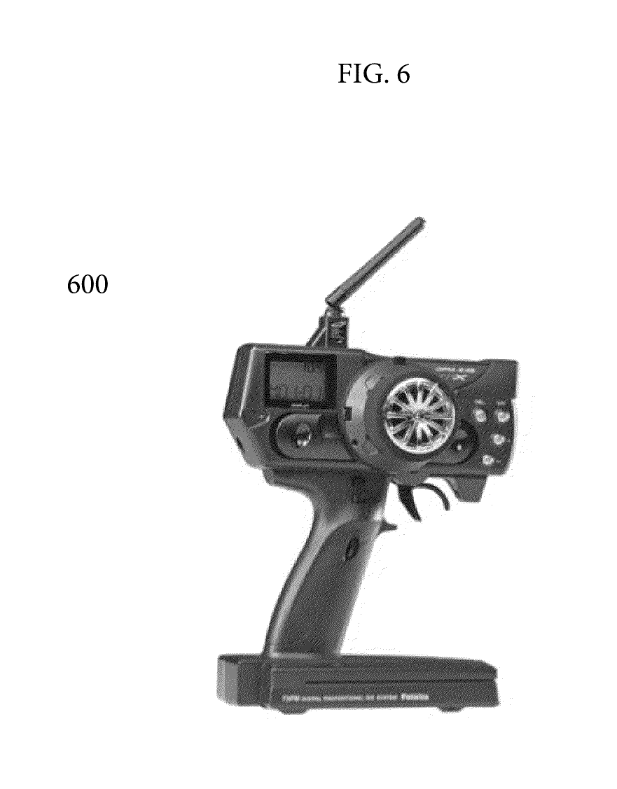

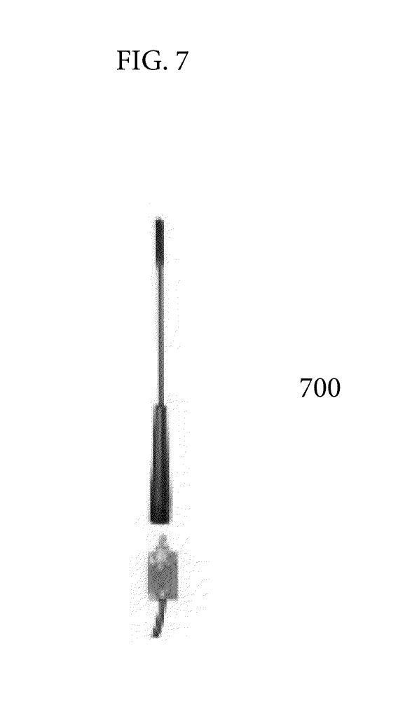

As illustrated in FIGS. 4, 6 and 7, the training device 100 can house a barrel unit 402, which can be metal; a light unit 404 attached to the barrel unit 402; an antenna 700; a removable remote control unit 600; a gearbox 300; and a high-capacity hopper device 102.

The light unit 404 can be an ultraviolet or infrared light unit that activates luminescent, biodegradable BBs as they are shot them through the barrel unit 402. Alternatively, a traditional tracer device can be used to light the BBs. The barrel unit 402 and light unit 404 combination can be attached to the gearbox 300, which shoots the BBs. The hopper device 102, in some embodiments, can hold up to 1000 plastic BBs and is used to create the perception of a device with a belt-fed PKM (PK modernized machine gun) or other medium caliber belt-fed machine gun.

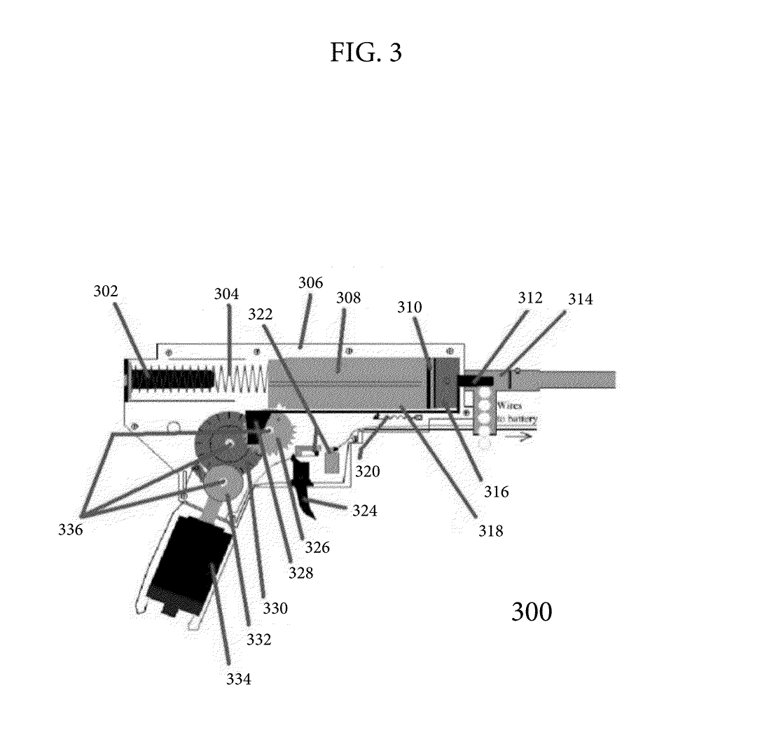

The removable remote control unit 600 can activate a gearbox 300 that operates the firing mechanism of the training device 100. In some embodiments, the gearbox 300 is metal. In some embodiments, as illustrated in FIG. 3, the gearbox 300 includes a spring guide 302, a spring 304, a gearbox shell 306, a piston 308, a piston head 310, an air nozzle 312, a hop-up 314, a cylinder head 316, a cylinder 318, a tappet return spring 320, contacts 322, a trigger 324, a setor gear 326, a tappet plate 328, a spur gear 330, a bevel gear 332, a motor 334, and axles 336 of gears, shims, and bushings.

The training device 100 can also include speakers 104, cable jacks, and lights to simulate a more realistic experience. In one embodiment, there are a plurality of speakers 104 as well as a subwoofer that can connect to the training device 100 using stereo wire. In one embodiment, the cable jacks can fit into an MP3 player or recorder so that military units, specialized law enforcement, and civilian high-threat security contractors can experience the sound of light or heavy machine gun firing.

In one embodiment, the training device 100 is portable and battery powered. It can use a battery 106 such as, but not limited to, a 12-volt rechargeable battery. It can be set up at live firing ranges, in MOUT (Military Operations on Urban Terrain) cities along roadways (for military lane training), or it can be positioned skyward for training with aviation units.

When in use, the training device 100 can be set up with the barrel unit 402 facing toward the individuals being trained. The speakers 104 can be removed from the training device 100 and configured in a manner for accurate sound projection. The removable remote control unit 600 can be similar to those used for remote control hobby vehicles and can operate the training device 100 remotely.

In use, the trigger 324 on the gearbox 300 is operated by a servo motor 500 attached to the gearbox's trigger 324. The servo motor 500 can attach to the trigger 324 on the gearbox 300 and, when activated, move and trigger firing of the device 100. Therefore, when the remote control unit 600 activates the training device 100, the remote control unit 600 can activate the servo motor 500, which causes the trigger 324 on the gearbox 300 to move, thus firing the gearbox 300.

The various embodiments described above are provided by way of illustration only and should not be construed to limit the claims attached hereto. Those skilled in the art will readily recognize various modifications and changes that may be made without following the example embodiments and applications illustrated and described herein and without departing from the true spirit and scope of the following claims.

What is claimed is:

1. A visual tracer and sound training device comprising:
a barrel unit;
a light unit attached to the barrel unit;
an antenna;
a removable remote control unit;
a gearbox;
a motor;
a high-capacity hopper device; and
speakers.

2. The training device of claim 1, further comprising cable jacks and lights.

3. The training device of claim 1, wherein the training device is portable.

4. The training device of claim 1, wherein the training device is battery powered.

5. The training device of claim 1, further comprising an infrared device attached to the barrel unit.

6. The training device of claim 1, further comprising an ultraviolet device attached to the barrel unit.
